(19) United States
(12) Patent Application Publication
(10) Pub. No.: US 2011/0009990 A1
(43) Pub. Date: Jan. 13, 2011

(54) DIGITAL MIXER

(75) Inventors: Kotaro TERADA, Hamamatsu-shi (JP); Hiroaki Fujita, Hamamatsu-shi (JP); Masaaki Okabayashi, Hamamatsu-shi (JP)

Correspondence Address: MORRISON & FOERSTER, LLP, 555 WEST FIFTH STREET, SUITE 3500, LOS ANGELES, CA, 90013-1024, US

(73) Assignee: Yamaha Corporation, Hamamatsu-Shi (JP)

(21) Appl. No.: 12/835,571

(22) Filed: Jul. 13, 2010

(30) Foreign Application Priority Data
Jul. 13, 2009 (JP) 2009-165153
Jul. 13, 2009 (JP) 2009-165154

(51) Int. Cl. G06F 17/00

(52) U.S. Cl. 700/94

(57) ABSTRACT

A digital mixer is provided with a plurality of signal processing channels each processing an audio signal in accordance with various kinds of parameters, and a plurality of channel strips each having a switch operating element and a control operating element to have one of the signal processing channels as a target channel which is to be controlled on the channel strip. The digital mixer is allowed to assign two or more channels to a channel strip at one time. When the switch operating element of the channel strip is manipulated, the channel strip switches the currently targeted channel to another channel different from the currently targeted channel among the channels assigned to the channel strip. When the control operating element of the channel strip is manipulated, a parameter value of the targeted channel of the channel strip is changed in accordance with the manipulation of the control operating element.

### BACKGROUND OF THE INVENTION

1. Field of the Invention

The present invention relates to a digital mixer having a capability of assigning user's desired channels to operating elements, respectively, provided on an external panel to allow the user to set or change a value/values of a parameter/parameters of a channel/channels assigned to one of the operating elements by a manipulation of the operating element.

2. Description of the Related Art

Conventionally, there have been digital mixers having physical operating elements such as faders and switches provided on an external panel (a mixing console). Some digital mixers are designed such that a console which is manipulated by a user is provided separately from a mixing engine which mixes input signals so that the console can be connected to the mixing engine with a cable. The other digital mixers are designed such that the console is integrated with the mixing engine. Whichever the digital mixer is, it is desired to save space necessary for the console in order to reduce the space required to install the digital mixer. In order to save the space, therefore, it is necessary to reduce the number of operating elements provided on the console. In recent years, however, because the number of channels processed on a digital mixer increases, it is of importance to handle a multiplicity of channels with a small number of operating elements. Particularly, efficiency, compactness and usability of the operating elements are desired for a digital mixer.

A prior art stated below discloses a digital mixer which has a plurality of channel strips each having operating elements such as a fader, a level meter and various buttons so that a user of the digital mixer can manipulate input channels that the user assigns to the channel strips, respectively. Schemes to assign the input channels to the channel strips include switching between layers (p. 45 of the prior art). By this scheme, the input channels of 48 channels, for example, are separated into the first layer of input channels 1 to 24 and the second layer of input channels 25 to 48 to allow the user to switch between the layers by use of a certain switch so that the input channels 1 to 24 or the input channels 25 to 48 are assigned to 24 channel strips, respectively. In this scheme, one channel is assigned to each channel strip regardless of whether the layer is on the first layer or on the second layer. Furthermore, the digital mixer of the prior art has a fader-assigning capability of assigning user's desired input channels to eight faders, respectively (p. 212 of the prior art). In this case as well, the number of input channel assigned to each fader is one.
Prior Art: DIGITAL MIXING CONSOLE PM5D/PM5D-RH V2, DIGITAL MIXING SYSTEM DSP5D User's Manual, 2004, Yamaha Corporation

### SUMMARY OF THE INVENTION

In the above-described prior art, in a case where the user desires to change the target channel which is to be controlled on a channel strip, the user has to switch from one layer to the other. Therefore, the digital mixer of the prior art is inconvenient in that the switching between the layers involves unnecessary switching of the channels assigned to channel strips that the user does not desire to change. Due to such an inconvenience, the digital mixer of the prior art is disadvantageous in that the flexibility in assignments of channels to the channel strips is low.

The present invention was accomplished to solve the above-described problem, and an object thereof is to provide a digital mixer for processing signals on a plurality of channels, the digital mixer enhancing flexibility in assignments of channels to the channel strips.

In order to achieve the above-described object, it is a feature of the present invention to provide a digital mixer including a plurality of processing channels each processing an audio signal in accordance with a parameter; a plurality of channel strips each having a switch operating element and a control operating element to have one of the signal processing channels as a target channel which is to be controlled on the channel strip; the switch operating element being an operating element for switching the signal processing channel targeted for control; and the control operating element being an operating element for controlling the parameter of the signal processing channel targeted for control; an assigning portion for assigning two or more processing channels to one of the channel strips; a switching portion for switching, when the switch operating element of one of the channel strips is manipulated, the processing channel targeted for control on the channel strip having the manipulated switch operating element from a currently assigned processing channel to another processing channel which is one of the two or more processing channels assigned to the channel strip having the manipulated switch operating element; and a changing portion for changing, when the control operating element of one of the channel strips is manipulated, a value of the parameter of the processing channel targeted for control on the channel strip having the manipulated control element in accordance with the manipulation of the control operating element.

The digital mixer for processing signals on a plurality of channels according to the present invention enhances flexibility in assignments of the channels to the channel strips. By manipulating the switch operating element of a channel strip, particularly, a user of the digital mixer is able to switch the signal processing channel targeted for control on the channel strip among the signal processing channels assigned to the channel strip. Therefore, the user of the digital mixer is able to easily switch the channel targeted for control by use of the control operating element of the channel strip and targeted for display on the display portion of the channel strip. That is, the digital mixer according to the present invention allows the user to easily switch the channel targeted for control on a channel strip by a manipulation of the switch operating element of the channel strip to refer to various kinds of information on the targeted channel or to change parameter values of the targeted channel.

### BRIEF DESCRIPTION OF THE DRAWINGS

FIG. 1 is a block diagram of a hardware configuration of a digital mixer according to an embodiment of the present invention;

FIG. 2 is a block diagram of a functional configuration of the digital mixer;

FIG. 3 is an external view (partial) of an external panel of the digital mixer;

FIG. 4 is an external view of layer switches provided on the external panel of the digital mixer;

FIG. 5 is example combinations of channel definition;

FIG. 6 is a flowchart of a channel definition process;

FIG. 7 is a flowchart of a custom layer creation process (example 1);

FIG. 8 is a flowchart of a custom layer creation process (example 2);

FIG. 9 is a flowchart of a layer switch depression process;

FIG. 10 is a flowchart of a control operating element manipulation process; and

FIG. 11 is a flowchart of a switch operating element manipulation process.

### DESCRIPTION OF THE PREFERRED EMBODIMENT

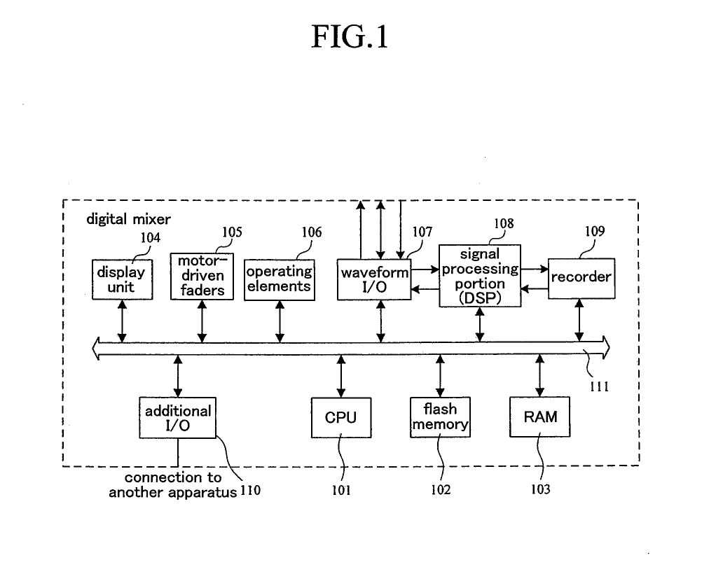

An embodiment of the present invention will now be described with reference to the drawings. FIG. 1 is a block diagram indicative of a hardware configuration of a digital mixer which is the embodiment of the present invention. A central processing unit (CPU) 101 is a processing unit which controls the entire mixer. A flash memory 102 is a nonvolatile memory which stores various kinds of programs executed by the CPU 101 and various kinds of data. A random-access memory (RAM) 103 is a volatile memory used as an area where programs executed by the CPU 101 are loaded and as a working area for the programs. A display unit 104 is a display provided on an operating panel of the mixer in order to display various kinds of information. Motor-driven faders 105 are operating elements provided on the operating panel in order to control levels. Operating elements 106 are various operating elements (other than the motor-driven faders) provided on the operating panel in order to be manipulated by a user. A waveform input/output interface (I/O) 107 is an interface for transmitting/receiving waveform signals to/from an external apparatus. A signal processing portion (DSP) 108 mixes waveform signals input through the waveform I/O 107, adds effects to the signals and controls respective levels of tone volume of the signals by executing various kinds of microprograms on the basis of instructions made by the CPU 101. The signal processing portion 108 then outputs the processed waveform signals through the waveform I/O 107. A recorder 109 records musical tone signals input from the DSP 108 and reproduces recorded musical tone signals. An additional I/O 110 is an interface for connecting another apparatus with the digital mixer. A bus 111, which is a bus line for connecting the above-described constituents with each other, is a generic name for control bus, data bus and address bus.

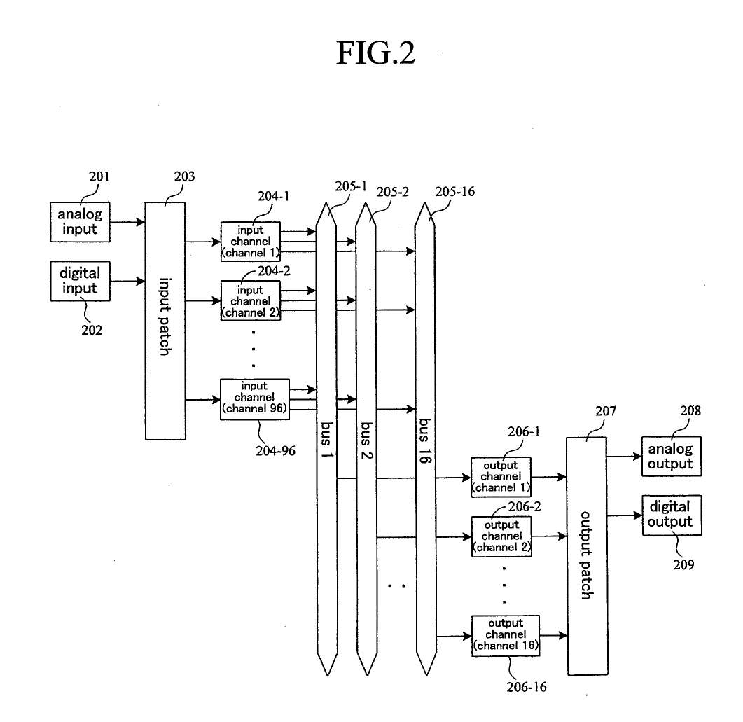

FIG. 2 is a block diagram indicative of a functional configuration of the digital mixer indicated in FIG. 1. An analog input 201 indicates an input obtained by converting an analog acoustical signal input by use of a microphone or the like into a digital signal. A digital input 202 indicates an input of a digital acoustical signal. There can be plural analog inputs 201 and plural digital inputs 202, although there are respective upper limits of the respective numbers of the inputs according to the configuration of the digital mixer. An input patch 203 connects the above-described input lines arbitrarily for input channels 204. The connections can be made by a user as desired on a certain screen. The input channels 204 have 96 separate single channels. Signals can be selectively output from the input channels 204 to sixteen MIX buses 205. Furthermore, respective send levels can be set separately. The respective input channels 204 process audio signals in accordance with set parameters.

Each of the sixteen MIX buses 205 mixes signals input from the input channels 204. The mixed signals are output to output channels 206 (channel 1 to channel 16) corresponding to the mix buses, respectively. The MIX buses 205 are in a one-to-one correspondence with the output channels 206. The respective output channels 206 process audio signals in accordance with set parameters. The output from the output channels 206 is input to an output patch 207. The output patch 207 connects the output channels 206 arbitrarily for an analog output 208 or a digital output 209. The connections can be made by the user as desired on a certain screen.

The input portions 201, 202 and the output portions 208, 209 are realized by the waveform I/O 107 of FIG. 1. The other portions 203 to 207 are realized by certain microprograms executed by the DSP 108. The microprograms are transmitted from the CPU 101 to the DSP 108 so that the DSP 108 can execute the microprograms. In addition, coefficient data used for the execution of the microprograms by the DSP 108 are also transmitted from the CPU 101 to the DSP 108.

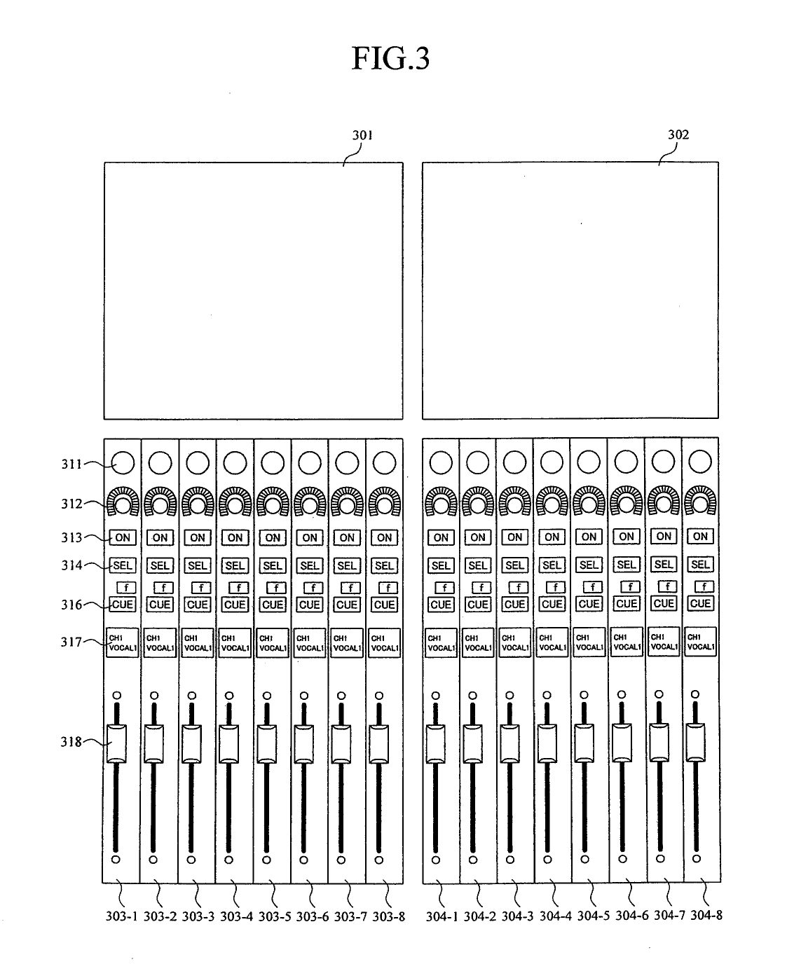

FIG. 3 is an external view (partial) of an external panel of the digital mixer of the embodiment. Displays 301, 302 (the display unit 104 of FIG. 1) display various kinds of information. Below the respective displays 301, 302, channel strip portions (the motor-driven faders 105 and the operating elements 106 of FIG. 1) are provided. The left channel strip portion has eight channel strips 303-1 to 303-8, and the right channel portion has eight channel strips 304-1 to 304-8. Each channel strip such as the channel strip 303-1 has rotary encoders 311, 312, an ON switch 313, a SEL switch 314, a CUE switch 316, a display 317 and a motor-driven fader 318. The rotary encoder 311 serves as an operating element whose function varies according to what is displayed on the upper display 301. The rotary encoder 312, which is a rotary encoder for controlling various parameters, has an LED used as a level meter provided around the encoder. The ON switch 313 switches a channel assigned to the channel strip 303-1 between on and off. The SEL switch 314 is used in order to select a channel assigned to the channel strip 303-1. The motor-driven fader 318 controls the level of the assigned channel. The knob of the motor-driven fader 318 can be placed at any position in accordance with instructions made by the CPU 101.

The RAM 103 of FIG. 1 has a current memory. The current memory stores respective current values of various parameters (including parameters for signal processing channels, of course) used on the digital mixer. As for the parameters which are included in the parameters stored in the current memory and related to signal processing performed by the DSP 108, current values of such parameters are also provided for the DSP 108 as coefficient data so that the DSP 108 can control various kinds of signal processing (mixing) in accordance with the current values. The current values of the parameters stored in the current memory can be changed by use of the motor-driven faders or the other operating elements. By a manipulation of an operating element of a channel strip indicated in FIG. 3, more specifically, a current value of a parameter which is stored in the current memory and corresponds to the manipulated operating element changes according to the manipulation, so that the changed new current value is provided for the DSP 108 to affect the signal processing performed by the DSP 108.

In FIG. 3, one or more channels can be assigned to each channel strip (e.g., 303-1). Conditions and a scheme adopted in order to assign channels to the respective channel strips will be described later. Channels assigned to a channel strip are options to choose from as a channel targeted for control by use of the channel strip. In this specification, assigning a channel to a channel strip means defining the channel as an option to choose as a channel targeted for control by use of the channel strip. On each channel strip, one of the signal processing channels assigned to the channel strip is chosen as a channel targeted for control. The channel targeted for control is the channel which is to be controlled by use of the operating elements of the channel strip. By using the operating elements (later-described control elements) of the channel strip, more specifically, respective current values of parameters of the signal processing channel chosen as the target channel can be changed. On the display 317 of the channel strip, furthermore, information on the parameter of the channel is displayed. In addition, the knob of the fader 318 of the channel strip is placed at a position corresponding to a current level value of the target channel. In this embodiment, moreover, in a case where a current value of a parameter of the channel targeted for control is changed by a manipulation of an operating element included in the channel strip, if there is the other channel/channels belonging to the same group as the target channel, a current value/values of the parameter of the other channel/channels is/are changed together. The “group” will be described in detail later.

The current memory is provided with assignment information storage areas and target storage areas for the respective channel strips. In the assignment information storage area, assignment information indicative of channels currently assigned to its corresponding channel strip is stored. In the target storage area, target channel information indicative of a channel currently set as a channel targeted for control on its corresponding channel strip is stored.

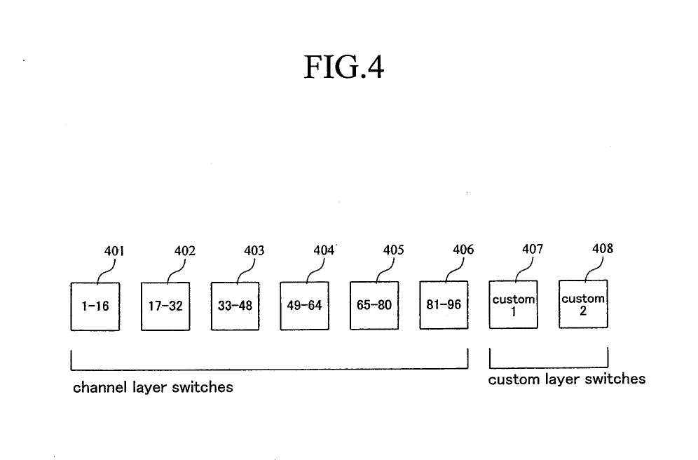

FIG. 4 indicates an external view of layer switches provided on the external panel of the digital mixer of the embodiment. A channel layer switch 401 is a switch for assigning channels 1 to 16. When the switch 401 is turned on, the channels 1 to 16 of the input channels are assigned to the sixteen channel strips 303-1 to 303-8, 304-1 to 304-8 of FIG. 3 from the left so that the channels 1 to 16 will be the target channels to be controlled on the respective channel strips, respectively. The channel layer switches 402 to 406 are similar. That is, the channel layer switches 402 to 406 are switches for assigning channels 17 to 32, channels 33 to 48, channels 49 to 64, channels 65 to 80, and channels 81 to 96, respectively, to the channel strips so that the respective channels will be the target channels to be controlled on the respective channel strips.

Custom layer switches 407, 408 (hereafter, referred to as custom layer switches 1, 2) are switches for reading out a custom layer file 1 or 2, respectively, to assign channels to the channel strips in accordance with the read custom layer file, and to make initial settings on the respective target channels. By the channel assignments by use of the custom layer file, a plurality of channels can be assigned to each channel strip.

Although this embodiment is designed such that the custom layer switches 1, 2 fixedly correspond to the custom layer files, 1,2, respectively, this embodiment may be modified to have a desired number of custom layer files so that the user can choose, from among the desired number of custom layer files, custom layer files which are to be assigned to the custom layer switches 1, 2, respectively.

Next, settings on channel definitions which are a premise for preparing the custom layer files will be described. On the digital mixer of this embodiment, 96 input channels for signal processing are previously divided into 12 blocks each having eight channels in ascending order of channel number. By displaying of a channel definition setting screen by a certain manipulation and designating a block definition for each block on the screen, the user is able to give a channel definition to each channel. The set channel definitions are stored in the flash memory 102. The available block definitions include “normal block”, “stereo block”, “surround 1 block” and “surround 2 block”. Once a block definition is designated for a block, each of the eight channels included in the block is given a channel definition on the basis of the block definition. The available channel definitions include “normal channel”, “stereo channel” and “surround channel”.

“Normal channel” indicates that the channel designated as “normal channel” handles normal audio signals as audio signals which are input to the channel. The normal audio signals are single signals which do not form any group. Input channels designated as “normal channels” do not form any group.

“Stereo channel” indicates that the channel designated as “stereo channel” handles stereo signals as audio signals which are input to the channel. The stereo signal is a signal which forms a group along with another audio signal with which the stereo signal has a stereo relationship. Each input channel designated as “stereo channel” is designated as either stereo channel (L) or stereo channel (R). Each stereo channel group is formed of the two input channels of the input channel designated as stereo channel (L) and the input channel designated as stereo channel (R).

“Surround channel” indicates that the channel designated as “surround channel” handles surround signals as audio signals which are input to the channel. The surround signal is a signal which forms a group along with other audio signals with which the surround signal forms a surround relationship. Each input channel designated as “surround channel” is designated as one of six channels: surround channel (L), surround channel (R), surround channel (C), surround channel (Ls), surround channel (Rs) and surround channel (LFE). “L”, “R”, “C”, “Ls”, “Rs”, and “LFE” indicate signals of front left (L), front right (R), center (C), left surround (Ls), right surround (Rs) and woofer (LFE) outputting deep bass sound, respectively. Each surround channel group has to have the six input channels: an input channel designated as the surround channel (L), an input channel designated as the surround channel (R), an input channel designated as the surround channel (C), an input channel designated as the surround channel (Ls), an input channel designated as the surround channel (Rs), and an input channel designated as the surround channel (LFE).

The above-described term, “group” used in the channel definition indicates a group of channels whose values of a parameter are concurrently controlled together. The input channels or the output channels provided on the digital mixer can form a plurality of groups. That is, all the input channels cannot be used to form a single group. In addition, all the output channels cannot be used to form a single group. The digital mixer of this embodiment may have any number of groups.

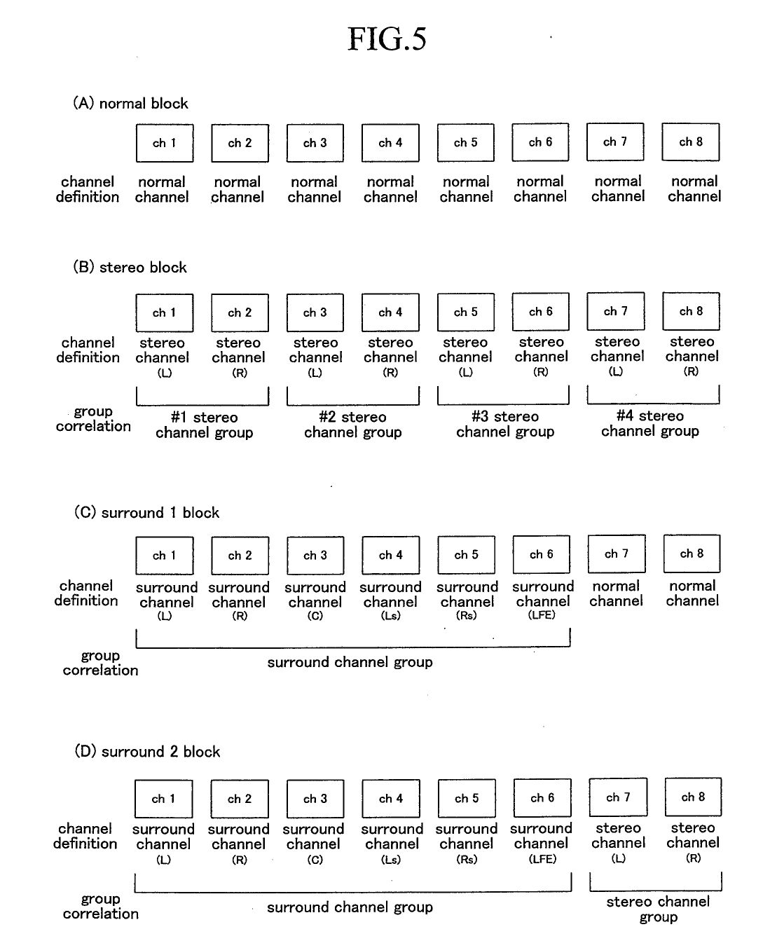

FIG. 5 indicates examples in which a block is given a block definition so that each channel belonging to the block can have a channel definition. FIG. 5(A) is a case where a block formed of the channels 1 to 8 is designated as “normal block”. In this case, each of the channels 1 to 8 is given a channel definition of “normal channel”.

FIG. 5(B) is a case where the block of the channels 1 to 8 is designated as “stereo block”. In this case, each of the channels 1 to 8 is given a channel definition of “stereo channel”. More specifically, these channels are divided into pairs in an ascending order of channel number so that the two channels of each pair can be correlated with each other as a stereo channel group. As a result, each pair forms a stereo channel group. Each pair is defined such that a channel of an odd channel number is the “L” of stereo, with a channel of the subsequent even channel number being the “R” of stereo. In the shown example of the block of the channels 1 to 8, the channel 1 and the channel 2 form a pair of stereo L, R, and the channel 3 and the channel 4 form a pair of stereo L, R, with the remaining channels similarly forming the pairs.

FIG. 5(C) is a case where the block of the channels 1 to 8 is designated as “surround 1 block”. In this case, the first six channels in ascending order of channel number are designated as “surround channels”, while the remaining two channels are designated as “normal channels”. The first six surround channels are assigned “L”, “R”, “C”, “Ls”, “Rs”, and “LFE”, respectively, in this order. The six channels of the channels 1 to 6 are correlated with each other as a surround channel group so that the six channels can form a surround channel group.

FIG. 5(D) is a case where the block of the channels 1 to 8 is designated as “surround 2 block”. In this case, the first six channels in ascending order of channel number are designated as “surround channels”, while the remaining two channels are designated as “stereo channels”. Similarly to the case of “surround 1 block”, the first six surround channels are assigned “L”, “R”, “C”, “Ls”, “Rs”, and “LEE”, respectively. The six channels of the channels 1 to 6 are correlated with each other as a surround channel group so that the six channels can form a surround channel group. The two channels of the channel 7 and the channel 8 are correlated with each other as a stereo channel group so that the two channels can form a stereo channel group.

Although FIG. 5 employs the examples of the block of the channels 1 to 8, each of the channels belonging to the other blocks can be similarly given a channel definition by providing a block definition for each of the other blocks. The respective channel definitions given to the respective channels are stored in the flash memory 102.

Because of the above-described channel definitions, in this embodiment, once the channel definition of a channel is identified, the type of signal designated for the channel and a channel/channels correlated with the channel as a group can be also identified on the basis of the channel definition of the channel. In a case where the channel definition of a channel is “stereo channel”, for example, there are two possibilities: (1) If the channel number of the channel is odd, the channel is “L”, while the subsequent channel is “R” which is paired with the channel. (2) If the channel number of the channel is even, the channel is “R”, while the preceding channel is “L” paired with the channel. In a case where the channel definition of the channel is “surround channel”, for example, depending on the channel's ordinal position counted from the top of the block, the channel can be identified as L, R, C, Ls, Rs or LFE. Depending on the channel's ordinal position, furthermore, the other channels correlated with the channel as a group can be identified. However, each channel definition may have information on the signal type of the channel and information on channels correlated with the channel as a group.

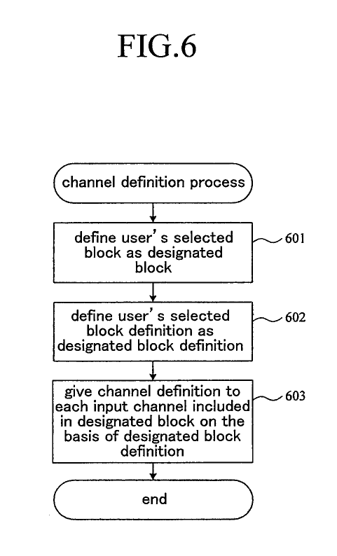

FIG. 6 is a flowchart of a channel definition process executed by the CPU 101 in order to set a channel definition for each channel. This process starts when the channel definition setting screen for setting channel definitions is displayed by a user's certain manipulation. The settings of channel definitions are included in initial settings of the digital mixer. Therefore, the user is required to set a channel definition for every input channel. On the channel definition setting screen, the user selects one of the twelve blocks by use of a switch displayed on the screen. In addition, the user selects one of the four block definitions described with reference to FIG. 5.

In FIG. 6, the block selected by the user is defined as a designated block in step 601. In step 602, the user's selected block definition is defined as a designated block definition. In step 603, on the basis of the designated block definition, each of the eight channels included in the designated block is given a channel definition. The details on the assignments of channel definition to the channels on the basis of the designated block definition have been described with reference to FIG. 5. The respective channel definitions given to the respective channels are stored in the flash memory 102. The user performs the process of FIG. 6 for every block so that every channel can be given a channel definition. As a result, every channel is to have a channel definition.

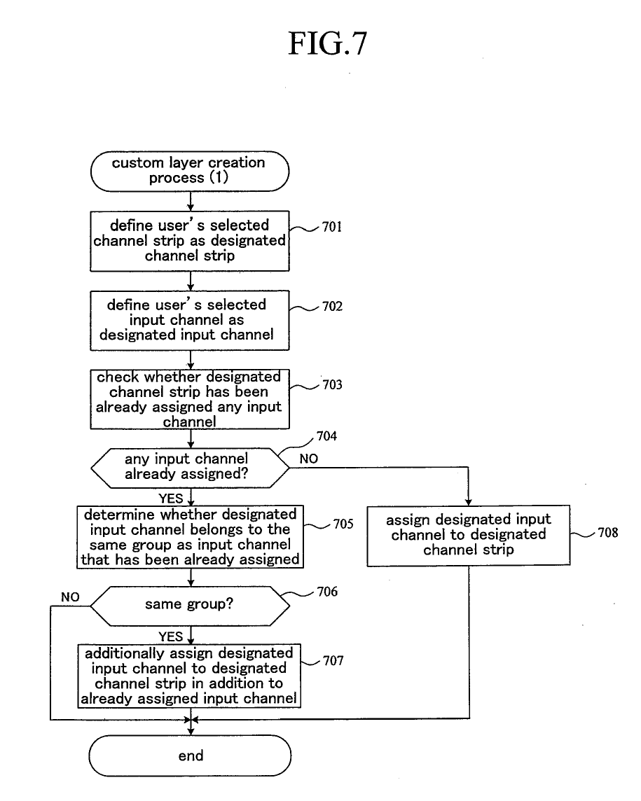

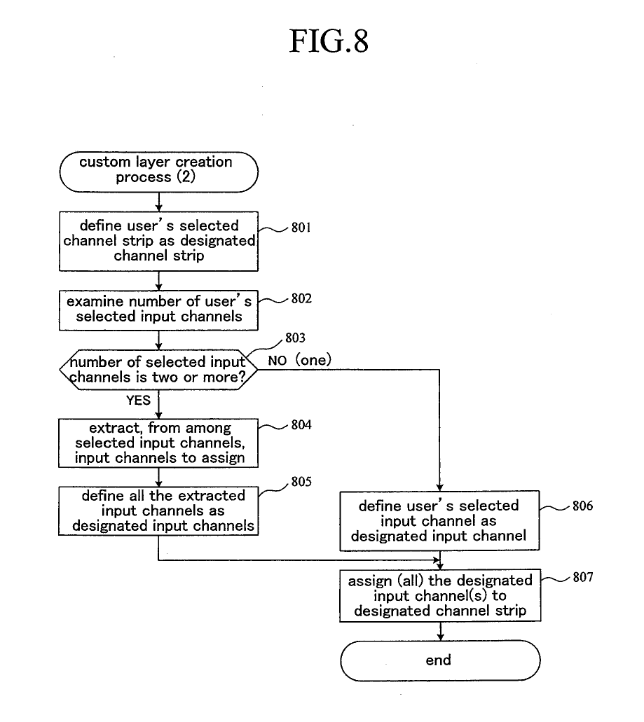

After setting the channel definitions for the respective channels as described above, the user creates (edits) the custom layer file. The digital mixer of this embodiment offers two types of manner of creating a custom layer file. The first manner of creating a custom layer file will be explained as an example 1 with reference to FIG. 7, while the second manner of creating a custom layer file will be explained as an example 2 with reference to FIG. 8. The custom layer files are stored in the flash memory 102.

When the user performs a certain manipulation to enter a custom layer file creation mode, the custom layer file creation mode starts to display a custom layer file creation screen (not shown). On the custom layer file creation screen, the user is able to make (change) the assignments of input channels to the respective channel strips stored in a custom layer file (in the case of this embodiment, the custom file 1 or 2) previously selected as a file to edit. In the custom layer file, the respective assignments of input channels to the sixteen channel strips 303-1 to 8, 304-1 to 8 (each channel strip may be assigned a plurality of channels) are recorded. The digital mixer of this embodiment offers two manners of editing the file (manners of changing respective assignments of input channels to the channel strips): the example 1 indicated in FIG. 7 and the example 2 indicated in FIG. 8.

FIG. 7 is a flowchart of a custom layer creation process (example 1). On the custom layer file creation screen, when the user selects a channel strip, and then selects an input channel which the user desires to assign to the channel strip, the process of FIG. 7 starts. The user makes such an assignment of an input channel to each of the sixteen channel strips.

In FIG. 7, the channel strip selected by the user is defined as a designated channel strip in step 701. In step 702, the input channel selected by the user is defined as a designated input channel. In step 703, it is determined whether any input channel has been already assigned to the designated channel strip. This determination is done by referring to the custom layer file targeted for edit to examine the channel assignment to the designated channel strip to check whether any input channel has been already assigned to the designated channel strip. When any input channel is not assigned to the designated channel strip (i.e., when the designated input channel which the user is about to assign is the first channel to be assigned to the designated channel strip), the process proceeds to step 708 to assign the designated input channel to the designated channel strip, with assignment information indicative of the assignment of the designated input channel to the designated input channel strip being written into the target custom layer file. After the step 708, the process terminates. In step 708, more specifically, the information indicative of the assignment of the designated input channel to the designated channel strip is recorded onto the custom layer file so that the custom layer file can store the information on the assignment of the designated input channel to the designated channel strip.

When it is determined in step 704 that any input channels have been already assigned to the designated channel strip (i.e., when the designated input channel which the user desires to assign to the designated input channel strip is the second or later input channel to be assigned to the channel strip), the process proceeds to step 705 to determine whether the designated input channel is correlated with any one of the input channels that have been already assigned to the channel strip as a group. The determination of step 705 is done by examining respective channel definitions of these input channels to check whether the two input channels, that is, the designated input channel and the input channel which has been already assigned to the channel strip, belong to the same group. In this embodiment, input channels are grouped according to their respective channel definitions as indicated in FIG. 5. In step 705, therefore, it is determined whether the two input channels belong to any one of the groups defined according to the rules of FIG. 5.

When it is determined in step 706 that the designated input channel is correlated with the assigned input channel as a group (that the two input channels belong to the same group), the process proceeds to step 707 to assign the designated input channel to the designated channel strip in addition to the input channel that has been already assigned. In step 707, furthermore, information on the additional assignment of the designated input channel to the channel strip is written into the target custom layer file before the process terminates. In step 707, more specifically, the information indicative of the assignment of the designated input channel to the designated channel strip is recorded onto the custom layer file so that the custom layer file can additionally store the information on the assignment of the designated input channel to the channel strip. When it is determined in step 706 that the designated input channel is not correlated with the input channel that has been already assigned, the designated input channel will not be assigned to the channel strip, with the assignment of the input channel that has been already assigned to the channel strip being kept in the custom layer file (without any change to the custom layer file). The process then terminates. The process may be modified such that in a case where it is determined in step 706 that the designated input channel is not correlated with the assigned input channel as a group, the input channel that has been already assigned is canceled so that the designated input channel can be newly assigned to the designated channel strip.

In a case where an input channel assigned to a channel strip as the first input channel is a normal channel, any input channel will not be allowed to be additionally assigned to the channel strip.

In a case where the channel definition of an input channel assigned to a channel strip as the first input channel is a stereo channel, the process of FIG. 7 allows the additional assignment only of an input channel correlated with the first input channel as a stereo channel group, without allowing assignments of any other channels to the channel strip. In a case where the channel definition of an input channel assigned to a channel strip as the first input channel is a surround channel, the process of FIG. 7 allows the additional assignments only of input channels correlated with the first input channel as a surround channel group, without allowing assignments of any other channels to the channel strip.

FIG. 8 is a flowchart of a custom layer creation process (example 2). On the custom layer file creation screen, when the user selects a channel strip, selects a desired number of input channels which the user desires to assign to the channel strip, and then depresses a certain confirmation switch provided on the custom layer file creation screen, the process of FIG. 8 starts. The user is allowed to select any number of input channels at one time. That is, the user can select one or more input channels. In a case of a plurality of input channels, more specifically, the user is allowed to select, at one time, even a plurality of input channels which do not belong to the same group. In the example 1 of FIG. 7, each time the user selects an input channel which the user desires to assign, the process of FIG. 7 is carried out to check the correlation between the channels. In the example 2 of FIG. 8, however, the process of FIG. 8 starts when a plurality of channels that the user desires to assign are selected. The digital mixer of this embodiment may employ only either the example 1 or example 2. Alternatively, the digital mixer may allow the user to select either the example 1 or example 2.

In FIG. 8, the channel strip selected by the user is defined as a designated channel strip in step 801. In step 802, the number of input channels selected by the user is obtained. In step 803, it is determined whether the number of input channels is one or more. When it is determined that the number of selected input channels is one, the process proceeds to step 806 to set the selected input channel as a designated input channel. The process then proceeds to step 807 to assign the designated input channel to the designated channel strip. In step 807, furthermore, information indicative of the assignment of the input channel to the channel strip is written, into the target custom layer file. Then, the process terminates. In step 807, more specifically, the information indicative of the assignment of the designated input channel to the designated channel strip is recorded onto the custom layer file so that the custom layer file can store the information on the assignment of the input channel to the channel strip. In a case where the designated channel strip has been already assigned any input channel, information indicative of the previous assignment of input channel to the channel strip is deleted, with only the information indicative of the new assignment of the input channel being recorded. That is, the custom layer file is updated so that the information indicative of the previous assignment can be replaced with the information indicative of the new assignment.

When it is determined in step 803 that the number of selected input channels is two or more, the process proceeds to step 804 to extract, from among the selected input channels, input channels which are to be assigned to the designated channel strip. For this extraction, first, for example, a reference channel is extracted from among the selected input channels. Then, all the input channels correlated with the reference channel as a group are extracted from the selected input channels. That is, input channels which are to be extracted are the reference channel extracted from among the selected input channels, and all the input channels which are included in the selected input channels and correlated with the reference channel as a group. For the extraction of the reference channel, for example, a reference channel is to be extracted according to a predetermined rule such as extracting a channel that the user has selected first, extracting a channel having the lowest channel number, or extracting a channel designated by the user. It should be noted that the above-described “all the input channels” are those included in the user's selected input channels. Even if there are channels which are correlated with the reference channel but are not included in the user's selected channels, more specifically, such channels will not be selected (extracted) as the input channels which are to be assigned together to the designated channel strip. The group correlation can be grasped by referring to the above-described channel definitions.

In a case where the extracted reference channel is a normal channel or a case where although the reference channel is a stereo channel or surround channel, the user's selected channels do not include any other channels correlated with the extracted reference channel as a group, only the reference channel is to be extracted (i.e., absence of input channels correlated with the reference channel as a group).

In step 805, all the extracted input channels are defined as designated input channels. In step 807, all the designated input channels are assigned to the designated channel strip. In step 807, in addition, assignment information indicative of the assignments of the input channels to the channel strip is written into the target custom layer file. Then, the process terminates. If it is found in step 807 at which the new assignment information is recorded as the information on the designated channel strip that information on an assignment of some channel to the channel strip has been already recorded on the custom layer file, the old information is deleted so that the new assignment information can be recorded (the old information is overwritten with the new assignment information). In step 807, that is, only the new assignment information is recorded as the assignment information on the designated channel strip.

The process of FIG. 8 extracts channels correlated with each other as a group from among a plurality of channels selected by the user in order to assign to a designated channel strip, and assigns the extracted channels to the channel strip. Therefore, the process of FIG. 8 allows assignments only of the channels correlated with each other as a stereo channel group or surround channel group to the channel strip, without allowing assignments of any other channels to the channel strip.

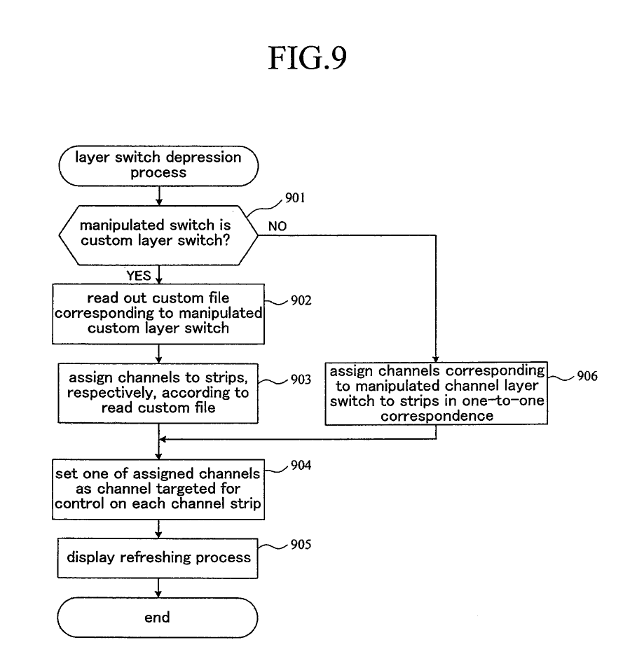

The respective processes of FIG. 7 and FIG. 8 are processes which only create assignment information which is the contents of the custom layer file, and write the created information into the custom layer file stored in the flash memory 102. In other words, the writing of the information on assignments of channels to a channel strip into the custom layer file will not result in changes in actual assignments of channels to the channel strip. In order to implement the assignment information stored in the custom layer file to affect the actual channel assignments to the channel strip, a later-described process of FIG. 9 has to be carried out in response to a user's depression of either of the layer switches 1 and 2. By the process of FIG. 9, more specifically, the assignment information stored in the custom layer file is read out into the assignment information storage areas of the current memory.

FIG. 9 is a flowchart of a layer switch depression process. This process starts when any one of the layer switches 401 to 408 indicated in FIG. 4 is depressed. In step 901, it is determined whether the depressed switch is either the custom layer switch 1 or 2. When the depressed switch is neither of them, that is, when any one of the channel layer switches 401 to 406 is depressed, the process proceeds to step 906 to assign the sixteen channels corresponding to the depressed channel layer switch to the channel strips 303-1 to 8, 304-1 to 8 in a one-to-one correspondence. The information on these assignments is stored in the assignment information storage areas of the current memory. After the step 906, the process proceeds to step 904.

When it is determined in step 901 that the depressed switch is either the custom layer switch 1 or 2, the process proceeds to step 902 to read the information on assignments stored in the custom layer file (1 or 2) corresponding to the depressed custom layer switch to assign, in step 903, channels to the respective channel strips in accordance with the read assignment information. In the respective assignment information storage areas of the current memory, by these steps, respective possible target channels are provided for the respective channel strips in accordance with the assignment information read from the custom layer file. After the step 903, the process proceeds to step 904.

The step 904 will be explained. In step 904, the respective numbers of input channels assigned to the respective channel strips in step 903 or 906 are checked. In a case where the number of channels assigned to a channel strip is one, the assigned input channel is stored in the target storage area of the current memory as a channel targeted for control on the channel strip. In a case where a channel strip is assigned two or more input channels, one of the assigned input channels is selected in accordance with a predetermined rule to store the selected input channel in the target storage area of the current memory as a channel targeted for control on the channel strip. The predetermined rule can be any rules as long as they control the selection of an input channel from among a plurality of channels. Such rules include a rule that an input channel having the smallest channel number should be selected. In a case where the step 904 follows the step 906, more specifically, an input channel is assigned to every channel strip in a one-to-one correspondence. In such a case; therefore, the respective input channels are set as respective target channels on the respective channel strips. In a case where the step 904 follows the step 903, an input channel is assigned to some channel strips whereas two or more input channels are assigned to the other channel strips. Therefore, it is necessary to check the number of assigned input channels for each channel strip to determine and set an input channel targeted for control for each channel strip. After the step 904, the process proceeds to step 905.

Input channels assigned to a channel strip (channels listed on the assignment information storage area of the current memory) are merely assigned as possible channels targeted for control by use of the operating elements of the channel strip. Therefore, a manipulation of the operating element of the channel strip will not necessarily result in actual control of all the assigned channels. That is, the input channel set at step 904 as the target channel is to be actually controlled by use of the operating elements of the channel strip so that a parameter value of the target channel can be controlled by use of the operating element corresponding to the parameter.

Next, refreshing of display at step 905 will be explained. As indicated in FIG. 3, each channel strip has the display 317. The display 317 is used in order to display various kinds of information on a target channel of a corresponding channel strip. The user is allowed to specify what kind of information on respective target channels is to be displayed on the display 317. In a case where the user instructs to display a current value of a parameter on each display 317, for example, the display 317 of each channel strip displays a current value of the parameter of a channel targeted on the channel strip. Such display control is performed by the CPU 101. In response to the determination of the respective target channels of the respective channel strips at step 904, the refreshing of display at step 905 is performed to refresh the screen of the display 317 of each channel strip whose target channel has been changed. By the refreshing of display in step 905, more specifically, the changes in the target channel will be taken effect to display information on the newly assigned target channels. In both the cases where the channel layer is selected and where the custom layer is selected, each channel strip is assigned one target channel. Therefore, what is displayed on the display 317 of each channel strip is information on its corresponding target channel.

On the displays 301, 302 indicated in FIG. 3, furthermore, various kinds of information can be displayed in various kinds of display modes. Such display modes include a mode by which pieces of information corresponding to the respective channel strips placed below are displayed (referred to as “channel strip display mode”). In the channel strip display mode, each of the displays 301, 302 is separated as if borders between the channel strips placed below extended upward to have respective display areas for the channel strips on the respective displays 301, 302. On the respective separated long display areas, various kinds of information on the respective target channels of the corresponding channel strips is displayed. In a case where the target channel which is to be controlled on the channel strip 303-1 is the channel 1, for example, a long display area which is placed above the channel strip 303-1 and has the width of the channel strip 303-1 is provided on the display 301 to display, on the display area, various kinds of information on the channel 1 which is the target channel of the channel strip 303-1. Similarly, the other channel strips are provided with the display areas, respectively. The display in the channel strip display mode is similar to the display on the display 317 of each channel strip in that information on each target channel is displayed. When the displays 301, 302 operate in the channel strip display mode, therefore, the refreshing of display in the step 905 updates what is displayed in the channel strip display mode.

By the refreshing of display in the step 905, furthermore, the respective motor-driven faders 318 of the channel strips whose target channels have been changed are controlled such that the respective knobs of such motor-driven faders 318 are placed at respective positions corresponding to respective current signal level values of the new target channels. In addition, the respective ON switches 313 and CUE switches 316 of the channel strips are also controlled to turn on/off in accordance with respective current values of the new target channels. Furthermore, the LEDs placed around the respective rotary encoders 312 are also controlled to illuminate in accordance with respective current values of the new target channels. By the refreshing of display in the step 905, as a result, the respective current values of the various kinds of parameters of the new target channels are displayed on the respective channel strips.

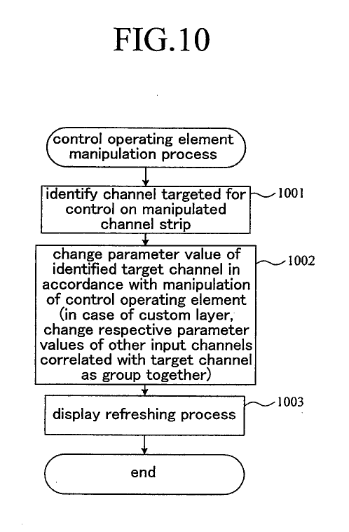

FIG. 10 is a flowchart of a process which starts when any of control operating elements included in the operating elements of a channel strip is manipulated. Among the operating elements provided on each channel strip described with reference to FIG. 3, the operating elements other than the SEL switch 314 (other than the switch element) are the control operating elements. More specifically, the operating elements 311, 312, 313, 316, 318 indicated in FIG. 3 are the control operating elements.

In step 1001, the target storage area of the current memory is referred to identify a target channel assigned to the channel strip having the manipulated control operating element. In step 1002, a parameter value of the identified target channel is changed in accordance with the manipulation of the control operating element. In step 1002, furthermore, the channel definition of the identified target channel is referred to check whether there are any input channels belonging to the same group as the identified target channel (whether there are any input channels whose parameter values are to be changed together with the parameter value of the target channel). More specifically, when the target channel belongs to a stereo channel group, a channel which is to be controlled together is an L channel or R channel. When the target channel belongs to a surround channel group, channels which are to be controlled together are an L channel, R channel, C channel, Ls channel and Rs channel, excluding an LFE channel. When there is/are the other input channel/channels which belong/belongs to the same group, the parameter value/values of the input channel/channels is/are also changed in accordance with the manipulation of the control operating element. When there are no other input channels belonging to the same group as the target channel, nothing will be done for the other input channels. It should be noted that a plurality of input channels defined by their channel definition as belonging to the same group are to be controlled such that respective values of a parameter of these input channels belonging to the same group are always controlled together regardless of whether these input channels are assigned to the same channel strip or not.

“Together” indicates that respective values of a parameter of a plurality of channels are changed concurrently in response to a single manipulation. That is, the single manipulation results in concurrent changes in the respective values of a parameter of one kind of the channels. More specifically, the amount of manipulation derived from the single manipulation is shared by the plurality of channels (i.e., each of the channel uses the amount of manipulation to change its parameter value). The manners of changing parameter values include a manner in which the respective parameter values of the channels change according to the amount of manipulation on the basis of absolute value, and a manner in which the parameter values change on the basis of relative value. The manner in which the respective parameter values change on the basis of absolute value (in which the respective parameter values change together on the basis of absolute value) is a manner in which a value determined according to the amount of manipulation is regarded as a new current value to replace the respective parameter values of the channels with the new current value, so that the new current value is respective new current values of the parameter of the channels. The manner in which the parameter values change on the basis of relative value (in which the parameter values change together on the basis of relative value) is a manner in which a new current value of the parameter of a channel is obtained on the basis of both a value determined according to the amount of manipulation and a current value of the parameter of the channel (e.g., addition/subtraction of the two values). By the relative manner, more specifically, a new current value of each of the channels is obtained on the basis of its current value and the value determined according to the amount of manipulation. Such linked control of respective parameter values is referred to as “linked control”.

The parameters of the input channels include parameters which are controlled together (linked parameters) and parameters which are not controlled together (non-linked parameters). In order to simplify explanations, in this embodiment, all the parameters that can be controlled by use of the control operating elements are regarded as linked parameters. In a case where parameters that can be controlled by the control operating elements include non-linked parameters, it is checked whether the parameter controlled by use of the control operating element is a linked parameter or a non-linked parameter. When it is determined that the parameter is a linked parameter, the process is performed as indicated in the flowchart. When it is determined that the parameter is a non-linked parameter, the parameter value of only the target channel is changed in step 1002 in accordance with the manipulation of the control operating element regardless of the channel definition of the target channel (regardless of whether the channel belongs to a group or not). Major linked parameters include EQ, compressor, tone volume level, on/off of channel, and pan. The linked parameters are mainly aimed at controlling sound characteristics of audio signals output from input channels. Major non-linked parameters include head amp gain, attenuator, delay and phase switch. The non-linked parameters are mainly aimed at controlling sound characteristics of audio signals input to the input channels.

After the step 1002, the process proceeds to step 1003 to refresh the display. In step 1003, as explained in step 905 of FIG. 9, various kinds of displays provided on the channel strip are refreshed in accordance with the manipulation.

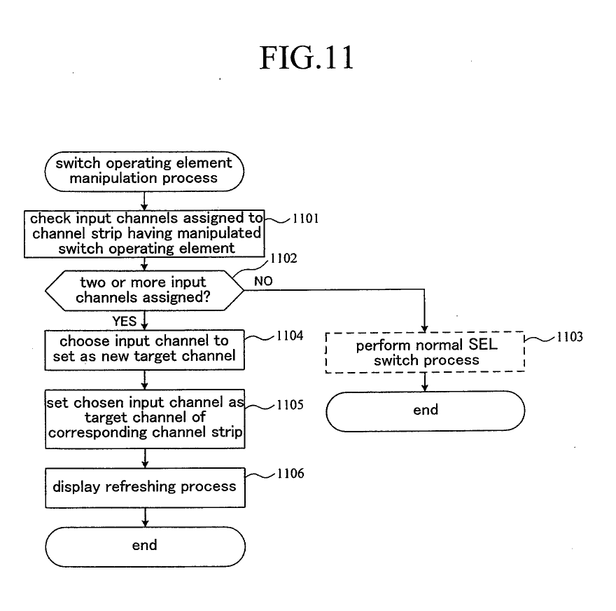

FIG. 11 is a flowchart of a process which starts when a switch operating element provided on each channel strip is manipulated. Among the operating elements provided on each channel strip described with reference to FIG. 3, the SEL switch 314 is the switch operating element. Normally, the SEL switch 314 of each channel strip serves as a switch for selecting a channel. In this embodiment, however, the SEL switch 314 of each channel strip is also used as a switch operating element. This embodiment may be also configured such that each channel strip has a switch operating element provided separately from the SEL switch 314. Each time the switch operating element of a channel strip is manipulated, the channel strip changes the target channel, selecting, in turn, one of the channels assigned to the channel strip. Each channel strip performs the selection of the target channel independently (without affecting the other channel strips).

In step 1101, the assignment information storage area of the current memory is referred to check input channels assigned to the channel strip whose switch operating element has been manipulated. In step 1102, it is determined whether two or more input channels are assigned to the channel strip. In a case where a channel layer is designated, one channel is assigned to each channel strip, that is, there is no possibility that a plurality of input channels are assigned to the channel strip. In the case of channel layer, therefore, the process proceeds to step 1103. In a case where a custom layer is designated, there is a possibility that a plurality of input channels are assigned to a channel strip. In the case of custom layer, therefore, it is determined how many input channels are assigned to the channel strip which has the manipulated switch operating element, so that the process proceeds to either YES or NO according to the number of assigned input channels.

In a case where it is determined in step 1102 that the number of assigned input channels is one, the process proceeds to step 1103 to perform the normal SEL switch process to terminate this process. More specifically, the input channel set as a channel targeted for control on the channel strip is assigned to a selected channel. Because this embodiment is designed such that the SEL switch 314 is also used as a switch operating element, the step 1103 is required. In a case where a switch operating element is provided separately from the SEL switch 314, however, the process terminates without performing the step 1103 (this is why the step 1103 is enclosed with a dotted box).

In a case where it is determined in step 1102 that the number of assigned input channels is two or more, the process proceeds to step 1104 to choose a new target channel. In step 1104, more specifically, a new target channel is selected from among the plurality of input channels (possible target channels) assigned to the channel strip having the manipulated SEL switch 314 in accordance with a predetermined rule. The plurality of input channels assigned to the channel strip can be grasped by referring to the assignment information storage area of the current memory. The input channel to be chosen in this step is an input channel different from an input channel which is the current target channel. The predetermined rule can be any rule as long as an input channel which is different from the current target channel can be chosen from among the input channels assigned to the channel strip. For instance, an input channel can be chosen in order of their channel numbers such as choosing an input channel of the channel number following or preceding the current target channel. Alternatively, the user can specify the order to choose a target channel so that an input channel which follows the current target channel can be chosen in accordance with the user's specified order.

In step 1105, the chosen input channel is set as the channel targeted for control on the channel strip (the chosen input channel is written into the target storage area of the current memory). Because the number of input channels assignable to a channel strip as a target channel is always one, the current target channel is replaced with the newly chosen input channel so that the newly chosen channel is set as a new target channel. Then, the process proceeds to step 1106 to refresh the display. In step 1106, as explained in step 905 of FIG. 9, various kinds of displays provided on the channel strip are refreshed in accordance with parameter values of the new target channel.

The user interface with which the user chooses a channel strip or a channel in the processes of FIG. 7 and FIG. 8 can be anything. On the custom layer file creation screen, for example, icons corresponding to the 16 channel strips and icons corresponding to the 96 input channels are displayed so that the user can choose a user's desired channel strip from among the 16 channel strips and a user's desired input channel to assign from among the 96 input channels. As for input channels which have been already assigned to any of the channel strips, furthermore, such channels may be displayed so that the user can recognize that the channels have been already assigned (e.g., such that the channels are displayed in a manner different from the manner in which assignable channels are displayed). Alternatively, such channels may be omitted from those channels which the user can choose to assign. Furthermore, when the user chooses an input channel, the channel definition of the channel stored in the memory may be referred to identify all the input channels correlated with the chosen channel as a group to present the identified input channels to the user. The input channels correlated with the chosen channel as a group are those channels belonging to the same group, that is, those channels assignable to the same channel strip. Alternatively, when an input channel is chosen, the channel definition of the channel stored in the memory may be referred to identify all the input channels which are not correlated with the chosen channel as a group to present the identified input channels to the user, or to omit the identified input channels from selectable channels. The input channels which are not correlated with the chosen channel as a group are those channels which do not belong to the same group as the chosen channel, so that they cannot be assigned to the same channel strip.

Hereafter, modified embodiments of the above-described embodiment will be described.

### a. Modified Embodiment 1

In the above-described embodiment, when a value of a parameter of a channel targeted for control is changed, respective values of the parameter of all the channels correlated with the target channel as a group are changed together (step 1002 of FIG. 10). However, there is another available scheme. By this scheme, that is, channels whose parameter values are to be changed together are not those which are correlated with the target channel but those identified on the basis of the assignment defined by the custom layer. By this modified scheme, for example, when a value of a parameter of a target channel is changed, the other channels assigned to the channel strip to which the target channel is assigned are extracted to change the respective values of the parameter of the extracted channels together. By this modified scheme, as a result, channels which are correlated with the target channel as a group but are not assigned to the same channel strip as the target channel are not to be controlled together with the target channel, so that the parameter values of such channels will not change together. In a case where a custom layer is in use, but there is no other channel assigned to the channel strip to which the target channel whose parameter value has been changed is assigned (i.e., in a case where the target channel is the only channel assigned to the channel strip), even if the target channel belongs to a group, the parameter value of only the target channel is to be changed, without changing respective parameter values of the other channels belonging to the same group.

### b. Modified Embodiment 2

In the above-described embodiment, the case has been described where the input channels are assigned to the channel strips, however, the present invention is not limited to the assignments of the input channels. As the modified embodiment 2, mixing channels, output channels or the like may be assigned to the channel strips. In a case where the output channels are assigned to the channel strips, the modified embodiment can be configured as in the case of input channels, by grouping the output channels on the basis of bus types (mix bus, stereo bus and surround bus) which the output channels handle.

### c. Modified Embodiment 3

Although the above-described embodiment employs the 5.1 ch surround, the present invention is also applicable to surround of a different number of channels (e.g., 6.1 ch surround and 7.1 ch surround).

### d. Modified Embodiment 4

Although the above-described embodiment is configured such that a channel definition is given to each block, the modified embodiment 4 may be configured such that each channel is individually given a channel definition. For example, the user chooses an input channel, and then gives a channel definition to the channel. Alternatively, when the user desires to form a stereo channel group or a surround channel group, the user chooses a necessary number of input channels in order to form the group, and then gives a channel definition of stereo channels or surround channels to the group.

### e. Modified Embodiment 5

In the above-described embodiment, the groups are defined by use of channel definitions of normal, stereo and surround. In the modified embodiment 5, however, channels may be grouped without these channel definitions. More specifically, the above-described embodiment may be modified such that a plurality of channels are assigned to a channel strip freely selected from among all the channels so that the assigned channels can form a group.

### f. Modified Embodiment 6

By the processes for creating or editing the custom layer file indicated in FIG. 7 and FIG. 8 of the above-described embodiment, the custom layer file is only rewritten. That is, the rewriting of the custom layer file does not involve actual changes in the assignments of input channels to the channel strips of the panel in accordance with the rewritten assignments. In other words, the above-described embodiment employs a scheme in which the rewriting of the custom layer file by the processes of FIG. 7 and FIG. 8 does not affect, in real time, the actual assignments of input channels to the channel strips of the panel.

Instead of the scheme described in the above-described embodiment, a scheme of the modified embodiment 6 may be employed in which the rewriting of the custom layer file involves actual changes in the assignments of input channels to the channel strips of the panel concurrently with the rewriting in accordance with the rewritten assignments. That is, the scheme in which the rewritten new assignments are reflected throughout the channel strips of the panel in real time in response to the rewriting of the custom layer file may be adopted.

In this case, as a preparation for the process of FIG. 7 or FIG. 8, when a target custom layer file is chosen, assignments of channels based on the chosen custom layer file are provided for the channel strips of the panel. More specifically, assignment information read from the custom layer file is written into the assignment information storage areas of the current memory.

Then, in step 708 of FIG. 7, the new assignment of the designated input channel to the designated channel strip is written into the custom layer file, with an assignment of an input channel to the channel strip provided on the panel being replaced with the new assignment (with the assignment information stored in the assignment information storage area of the current memory being updated). In addition, the newly assigned input channel targeted for control on the channel strip is provided for the target storage area of the current memory. Because the number of input channels assigned to a channel strip in this step is always one, the input channel is to be set as a target channel of the channel strip.

In step 707 of FIG. 7, similarly, the new assignment of the designated input channel to the designated channel strip is written into the custom layer file, with an assignment of an input channel to the channel strip provided on the panel being replaced with the new assignment (with the assignment information stored in the assignment information storage area of the current memory being updated). In addition, the newly assigned input channel targeted for control on the channel strip is provided for the target storage area of the current memory. In the case of step 707, because a plurality of input channels are to be assigned to the designated channel strip, the newly added input channel is provided as a target channel of the channel strip. Of course, a scheme may be adopted in which an input channel which has been provided for the channel strip as a target channel is kept as a target channel without employing the newly assigned input channel as a target channel.

In step 807 of FIG. 8, similarly, the new assignment of the designated input channel to the designated channel strip is written into the custom layer file, with an assignment of an input channel to the channel strip provided on the panel being replaced with the new assignment (with the assignment information stored in the assignment information storage area of the current memory being updated). In the case of the process of FIG. 8, in a case where the process has passed through step 806, because the number of input channels assigned to the designated channel strip is always one, the newly assigned input channel is provided for the target storage area of the current memory as a target channel of the channel strip. In a case where the process has passed through step 805, because a plurality of input channels are to be assigned to the designated channel strip, one of the newly assigned input channels is provided for the target storage area of the current memory as a target channel of the channel strip. The method to choose an input channel which is to be a target channel can be any method (as described in the explanation for FIG. 7).

What is claimed is:

1. A digital mixer comprising:
a plurality of processing channels each processing an audio signal in accordance with a parameter;
a plurality of channel strips each having a switch operating element and a control operating element to have one of the signal processing channels as a target channel which is to be controlled on the channel strip;
the switch operating element being an operating element for switching the signal processing channel targeted for control; and the control operating element being an operating element for controlling the parameter of the signal processing channel targeted for control;
an assigning portion for assigning two or more processing channels to one of the channel strips;
a switching portion for switching, when the switch operating element of one of the channel strips is manipulated, the processing channel targeted for control on the channel strip having the manipulated switch operating element from a currently assigned processing channel to another processing channel which is one of the two or more processing channels assigned to the channel strip having the manipulated switch operating element; and
a changing portion for changing, when the control operating element of one of the channel strips is manipulated, a value of the parameter of the processing channel targeted for control on the channel strip having the manipulated control element in accordance with the manipulation of the control operating element.

2. A digital mixer according to claim 1, further comprising:
a channel definition setting portion for giving each of the processing channels a channel definition by which the processing channel is able to identify the other processing channels used as a group, wherein
the assigning portion assigns two or more processing channels belonging to the group to one of the channel strips.

3. A digital mixer according to claim 2, wherein
the assigning portion further includes:
a channel strip setting portion for defining a channel strip selected from among the plurality of channel strips as a designated channel strip;
a processing channel setting portion for defining a processing channel selected from among the plurality of processing channels as a designated processing channel;
a determination portion for determining whether any processing channel has been already assigned to the designated channel strip selected from among the plurality of channel strips;
a first assigning portion for assigning, when it is determined by the determination portion that any processing channel has not been assigned to the designated channel strip yet, the designated processing channel to the designated channel strip defined by the channel strip setting portion; and
a second assigning portion for assigning, when it is determined by the determination portion that one or more of the plurality of processing channels have been already assigned to the designated channel strip, the designated processing channel to the designated channel strip on condition that the designated processing channel belongs to the group to which any of the one or more processing channels which have been already assigned belongs.

4. A digital mixer according to claim 2, wherein
the assigning portion further includes:
a channel strip setting portion for defining a channel strip selected from among the plurality of channel strips as a designated channel strip;
an extraction portion for extracting, from among some processing channels selected from among the plurality of processing channels, processing channels belonging to the same group; and
an assigning portion for assigning the extracted processing channels to the designated channel strip.

5. A digital mixer according to claim 2, wherein
the channel definition defining the processing channels as being used as the group prescribes that the two processing channels are stereo channels having right and left channels used as the group.

6. A digital mixer according to claim 2, wherein
the channel definition defining the processing channels as being used as the group prescribes that the six processing channels are used as the group for processing signals of front left, front right, center, left surround, right surround and deep bass sound, respectively.

7. A digital mixer according to claim 2, wherein
when the control operating element of one of the channel strips is manipulated, the changing portion also changes a value of the parameter of the processing channel belonging to the same group as the processing channel assigned to the channel strip having the manipulated control operating element in accordance with the manipulation of the control operating element.

8. A digital mixer according to claim 1, wherein
when the control operating element of one of the channel strips is manipulated, the changing portion also changes respective values of the parameter of the two or more processing channels assigned to the channel strip having the manipulated control operating element in accordance with the manipulation of the control operating element.

9. A digital mixer according to claim 1, wherein
each of the plurality of channel strips has a display portion; and
the digital mixer further comprises a display control portion for controlling display regarding the parameter of the processing channel targeted for control on the corresponding channel strip on the display portion of the corresponding channel strip.
